(19) United States
(12) Patent Application Publication
(10) Pub. No.: US 2026/0299311 A1
(43) Pub. Date: Oct. 1, 2026

(54) OPTICAL ENGINE SYSTEM, DISPLAY METHOD AND DISPLAY APPARATUS FOR DISPLAY SCREEN, DEVICE, MEDIUM, AND PRODUCT

(71) Applicant: Ningbo Top Micron Semiconductor Co. Ltd., Ningbo (CN)

(72) Inventors: Ying QIN, Ningbo (CN); Wenqian SUN, Ningbo (CN); Caiyun HE, Ningbo (CN); Xiurong CAI, Ningbo (CN); Yin PENG, Ningbo (CN); Xiaolong MA, Ningbo (CN); Youxi Lin, Ningbo (CN)

(21) Appl. No.: 19/279,904

(22) Filed: Jul. 24, 2025

(30) Foreign Application Priority Data
Mar. 28, 2025 (CN) 202510384934.8

(51) Int. Cl. G02B 27/10; G02B 27/12; G09G 3/20; G09G 3/32

(52) U.S. Cl. CPC G02B 27/1086; G02B 27/126; G09G 3/2074; G09G 3/32; G09G 2300/0452; G09G 2320/0233; G09G 2320/0242; G09G 2320/0686

(57) ABSTRACT

A optical engine system comprises: a display screen and a color-combining device. The display screen comprises a first display region and a second display region, a pixel in the first display region comprises a first color sub-pixel, a pixel in the second display region comprises at least one of a second color sub-pixel or a third color sub-pixel. The display screen is configured to receive a grayscale value of a sub-pixel in a to-be-displayed image corresponding to a color, to display brightness corresponding to the grayscale value in the first display region or the second display region that comprises the sub-pixel of the color, and the color-combining device is configured to combine a light ray emitted from the first display region and a light ray emitted from the second display region.

### CROSS REFERENCE TO RELATED APPLICATION

The present application claims priority to Chinese Patent Application No. 202510384934.8, entitled “Optical Engine System, Display Method and Display Apparatus for Display Screen, Device, Medium, and Product”, and filed with China National Intellectual Property Administration on Mar. 28, 2025, the content of which is expressly incorporated herein by reference in its entirety.

### TECHNICAL FIELD

The present disclosure relates to the field of optical display technology, particularly to an optical engine system, a display method and a display apparatus for a display screen, a device, a medium, and a product.

### BACKGROUND

Due to the characteristics of silicon-based Micro Light Emitting Diode (LED) such as high pixel density, high brightness, and low power consumption, etc., the silicon-based Micro LED often serves as an optical engine light source in an Augmented Reality (AR) head-mounted display device.

With the development of optical display technology, more and more AR head-mounted display devices based on silicon-based Micro LEDs are emerging. However, to implement a full-color display of the AR head-mounted display device, the existing optical engine system has a relatively high manufacturing cost and a complex manufacturing process, so that all existing AR head-mounted display devices can only perform monochromic display.

### SUMMARY

In view of the above, as for the above technical problem, it is necessary to provide an optical engine system, a display method and a display apparatus for a display screen, a device, a medium, and a product capable of performing full-color display.

In the first aspect of the present disclosure, an optical engine system is provided, including a display screen and a color-combining device. The display screen comprises a first display region and a second display region, a pixel in the first display region comprises a first color sub-pixel, a pixel in the second display region comprises at least one of a second color sub-pixel or a third color sub-pixel; the first color, the second color, and the third color are respectively one of three primary colors, pixels in the first display region are in a one-to-one correspondence with pixels in the second display region, the display screen is configured to receive a grayscale value of a sub-pixel in a to-be-displayed image corresponding to a color, to display brightness corresponding to the grayscale value in the first display region or the second display region that comprises the sub-pixel of the color, color types of sub-pixels included in pixels in the to-be-displayed image are the same as color types of sub-pixels in the display screen, and the color-combining device is configured to combine a light ray emitted from the first display region and a light ray emitted from the second display region.

In an embodiment, when the pixel in the second display region comprises only the second color sub-pixel or only the third color sub-pixel, the color-combining device is a color-combining prism or an optical waveguide color-combining device; and when the pixel in the second display region comprises both the second color sub-pixel and the third color sub-pixel, the color-combining device is the color-combining prism.

In an embodiment, the optical waveguide color-combining device includes: first optical input-coupling diffraction gratings, a first optical waveguide channel, and first optical output-coupling diffraction gratings that correspond to the first display region, and second optical input-coupling diffraction gratings, a second optical waveguide channel, and second optical output-coupling diffraction gratings that correspond to the second display region. The first optical input-coupling diffraction gratings are configured to import light rays emitted from the first display region into the first optical waveguide channel through diffraction, the first optical waveguide channel is configured to transmit the imported light rays to the first optical output-coupling diffraction gratings, the first optical output-coupling diffraction gratings are configured to export, through diffraction, the light rays transmitted by the first optical waveguide channel, the second optical input-coupling diffraction gratings are configured to import light rays emitted from the second display region into the second optical waveguide channel through diffraction, the second optical waveguide channel is configured to transmit the imported light rays to the second optical output-coupling diffraction gratings, and the second optical output-coupling diffraction gratings are configured to export, through diffraction, the light rays transmitted by the second optical waveguide channel.

In an embodiment, a grating plane of any one diffraction grating of the first optical input-coupling diffraction gratings, the second optical input-coupling diffraction gratings, the first optical output-coupling diffraction gratings, or the second optical output-coupling diffraction gratings is engraved with a plurality of grooves, an incident angle of the diffraction grating is related to a width and a blaze angle of a groove, and a diffraction angle of the diffraction grating is related to the width and the blaze angle of the groove, wherein the incident angle is an angle between an incident light ray and a grating normal, the diffraction angle is an angle between a diffracted light ray and the grating normal, and the blaze angle is an angle between an inclined surface of the groove and the grating plane.

In an embodiment, when the color-combining device is the optical waveguide color-combining device, the system further comprises a lens group consisting of a plurality of lenses. The lens group is configured to process different light rays emitted from the display screen, to allow light rays incident on the same optical input-coupling diffraction grating to be parallel to each other.

In the second aspect of the present disclosure, a display method for a display screen is provided, which is applied to the above-mentioned optical engine system. The method includes: acquiring a grayscale value of a sub-pixel of a pixel in a to-be-displayed image corresponding to a to-be-displayed color; acquiring a first correspondence between the pixel in the to-be-displayed image and a pixel in a first display region of the display screen, and a second correspondence between the pixel in the to-be-displayed image and a pixel in a second display region of the display screen; controlling the pixel in the first display region to display brightness corresponding to the grayscale value based on the first correspondence when a color of a sub-pixel in the first display region is the same as the to-be-displayed color; and controlling the pixel in the second display region to display brightness corresponding to the grayscale value based on the second correspondence when a color of a sub-pixel in the second display region includes the to-be-displayed color.

In the third aspect of the present disclosure, a display apparatus for a display screen is provided, including: a first acquisition unit, configured to acquire a grayscale value of a sub-pixel of a pixel in a to-be-displayed image corresponding to a to-be-displayed color; a second acquisition unit, configured to acquire a first correspondence between the pixel in the to-be-displayed image and a pixel in a first display region of the display screen and a second correspondence between the pixel in the to-be-displayed image and a pixel in a second display region of the display screen; a first control unit, configured to control the pixel in the first display region to display brightness corresponding to the grayscale value based on the first correspondence when a color of a sub-pixel in the first display region is the same as the to-be-displayed color; and a second control unit, configured to control the pixel in the second display region to display brightness corresponding to the grayscale value based on the second correspondence when a color of a sub-pixel in the second display region includes the to-be-displayed color.

In the fourth aspect of the present disclosure, a computer device is provided, including a processor and a memory storing a computer program. The processor, when executing the computer program, implements the method of any one of the above embodiments.

In the fifth aspect of the present disclosure, a non-transitory computer-readable storage medium is provided, on which a computer program is stored. The computer program, when executed by a processor, causes the processor to implement the method of any one of the above embodiments.

In the sixth aspect of the present disclosure, a computer program product is provided, including a computer program. The computer program, when executed by a processor, causes the processor to implement the method of any one of the above embodiments.

According to the above-mentioned optical engine system, display method and display apparatus for the display screen, device, medium, and product, during the process of manufacturing the display screen, a first display region and a second display region may be provided in the display screen according to requirements. A pixel in the first display region includes a first color sub-pixel, and a pixel in the second display region includes at least one of a second color sub-pixel or a third color sub-pixel. In such a manner, both a display screen capable of implementing the full-color display and a display screen capable of implementing the dual-color display can be produced. Accordingly, display requirements for different AR head-mounted display devices can be satisfied as far as possible. In addition, the cost of producing the display screen is relatively low, and the production process is relatively simple.

### BRIEF DESCRIPTION OF THE DRAWINGS

To describe the technical solution in the embodiments of the present disclosure or the related technologies more clearly, accompanying drawings required for describing the embodiments of the present disclosure or the related technologies are briefly introduced below. Obviously, the accompanying drawings in the following description show merely some embodiments of the present disclosure, and those skilled in the art may obtain other related drawings according to these accompanying drawings without any creative efforts.

FIG. 1 is a schematic diagram of an optical engine system according to an embodiment.

FIG. 2 is a plan view of a display screen according to an embodiment.

FIG. 3 is a color-combining optical path diagram of a color-combining prism according to an embodiment.

FIG. 4 is a schematic diagram of an optical waveguide color-combining device according to an embodiment.

FIG. 5 is a schematic diagram of diffraction gratings according to an embodiment.

FIG. 6 is a flow chart showing a display method for a display screen according to an embodiment.

FIG. 7 is a schematic structure diagram of a display apparatus for a display screen according to an embodiment.

FIG. 8 is an internal structure diagram of a computer device according to an embodiment.

### REFERENCE NUMERALS

101, display screen; 1011, first display region; 1012, second display region; 102, color-combining device.

### DETAILED DESCRIPTION

Unless otherwise defined, all technical and scientific terms used in the present disclosure have the same meaning as those commonly understood by those skilled in the art that belongs to the present disclosure. The terms used in the specification of the present disclosure are merely intended to describe specific embodiments and are not intended to limit the present disclosure.

It should be appreciated that the terms “first”, “second” and the like used in the present disclosure may be used for describing various components in the specification, but the components are not limited by these terms. These terms are only used for distinguishing the first element from the other. For example, without departing from the scope of the present disclosure, a first resistor may be referred to as a second resistor, and similarly, the second resistor may be referred to as the first resistor. The first resistor and the second resistor are both resistors, but they are not the same resistors.

It should be appreciated that “connection” in the following embodiments should be regarded as “electrical connection”, “communication connection”, and the like when there exists an electrical signal or data transmission among the connected circuits, modules, units, and the like.

In use herein, the singular forms “a”, “one” and “the/said” may also include plural forms unless the context clearly indicates another manner. It should also be appreciated that the term “including/comprising” or “having”, etc., specifies the presence of the stated features, entirety, steps, operations, components, portions, or combinations thereof, but does not exclude the possibility of existing or adding one or more other features, entirety, steps, operations, components, portions or combinations thereof. At the same time, the term “and/or” used in the present disclosure includes any and all combinations of the items listed.

To make the purpose, technical solution, and advantages of the present disclosure clearer, the present disclosure will be elaborated with reference to accompanying drawings and embodiments. It should be appreciated that the specific embodiments described herein are merely used for explaining the present disclosure, and are not intended to limit the present disclosure.

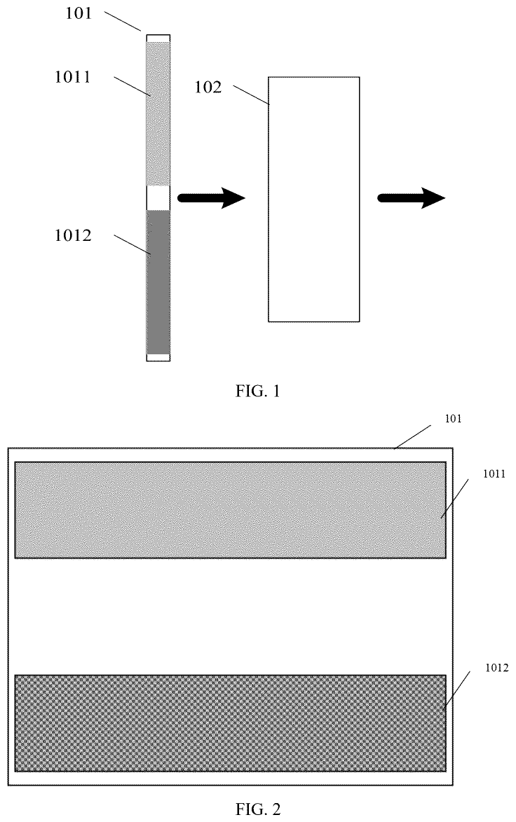

In an embodiment of the present disclosure, an optical engine system is provided, as shown in FIG. 1. The optical engine system in FIG. 1 includes a display screen 101 and a color-combining device 102. The display screen 101 includes a first display region 1011 and a second display region 1012. A pixel in the first display region 1011 includes a first color sub-pixel. A pixel in the second display region 1012 includes at least one of a second color sub-pixel or a third color sub-pixel. The first color, the second color, and the third color are respectively one of three primary colors. Pixels in the first display region 1011 are in a one-to-one correspondence with pixels in the second display region 1012. The display screen 101 is configured to receive a grayscale value of a sub-pixel in a to-be-displayed image corresponding to a color, to display brightness corresponding to the grayscale value in the first display region 1011 or the second display region 1012 that includes the sub-pixel of the color. Color types of sub-pixels included in pixels in the to-be-displayed image are the same as color types of sub-pixels in the display screen 101. The color-combining device 102 is configured to combine a light ray emitted from the first display region and a light ray emitted from the second display region.

Optionally, positions and areas of the first display region 1011 and the second display region 1012 on the display screen 101 are determined under a condition that a color-combining effect of the color-combining device 102 is optimal. The areas of the first display region 1011 and the second display region 1012 are the same.

Optionally, in a case where the optical engine system is configured to perform full-color display, pixels in the second display region 1012 include second color sub-pixels and third color sub-pixels. FIG. 2 is a plane view of the display screen 101. In FIG. 2, small blocks with a relatively dark color in the second display region 1012 represent the second color sub-pixels, and small blocks with a relatively light color represent the third color sub-pixels. Adjacent two small blocks with a relatively dark color and a relatively light color represent two sub-pixels included in one pixel. For example, if the first color is red (R), the second color may be blue (B), and the third color may be green (G). In FIG. 2, the remaining regions except for the first display region 1011 and the second display region 1012 are blank regions where the brightness display is not performed. In a case where the optical engine system is configured to perform dual-color display, a pixel in the second display region 1012 includes only the second color sub-pixel or the third color sub-pixel. Exemplary schemes for the full-color display and the dual-color display may be shown in the following Table 1.

TABLE 1

| | Scheme 1 | Scheme 2 | Scheme 3 | Scheme 4 | Scheme 5 | Scheme 6 |
|---|---|---|---|---|---|---|
| First display | G | B | R | G | B | R |
| region | | | | | | |
| Second display | R&B | R&G | B&G | B | G | G |
| region | | | | | | |
| Notes | full-color | full-color | full-color | dual-color | dual-color | dual-color |
| | scheme | scheme | scheme | scheme | scheme | scheme |

Optionally, in a case where the optical engine system in the embodiment is configured for the AR head-mounted display device, the display screen 101 provides a light source for the color-combining device 102 by displaying based on the to-be-displayed image. The color-combining device 102 combines light rays emitted from different display regions on the display screen 101, and projects the combined light rays into human eyes, so that the human eyes can see a picture in the to-be-displayed image.

Optionally, when the display screen 101 is a Micro LED display screen, the display screen 101 includes a display panel and a Complementary Metal-Oxide-Semiconductor (CMOS) drive backplane stacked together. The first display region 1011 and the second display region 1012 are located in the display panel. An Integrated Circuit (IC) transmits image data of the to-be-displayed image to the display screen 101 through a data interface, and the CMOS drive backplane splits the image data to obtain image data of each color sub-pixel of each pixel in the to-be-displayed image, and allocates the image data to pixels in a display region having the same color for the image data of each color sub-pixel, to perform the display. The image data includes a grayscale value.

Optionally, in the process of manufacturing the display screen 101, it is only necessary to bond peripheral extensions of the first display region 1011 and the second display region 1012 on the CMOS drive backplane respectively, and then unify an LED pattern process of exposure, development, and etching.

Optionally, in the process of driving the display panel 101, a pixel in the first display region 1011 and a pixel in the second display region 1012 may be separately driven. The driving processes of the first display region 1011 and the second display region 1012 are simultaneously performed. The driving process includes row driving and column driving. Row signals are driven row by row by a gate driver through a scan line, and column signals are driven through data signals transmitted row by row by a data driver.

In the process of manufacturing the display screen, the above-mentioned optical engine system may be set with the first display region and the second display region in the display screen according to requirements. A pixel in the first display region includes a first color sub-pixel, and a pixel in the second display region includes at least one of a second color sub-pixel or a third color sub-pixel. In such a manner, both a display screen capable of implementing the full-color display and a display screen capable of implementing the dual-color display can be produced. Accordingly, display requirements for different AR head-mounted display devices can be satisfied as far as possible. In addition, the cost of producing the display screen is relatively low, and the production process is relatively simple.

In some embodiments, in a case where a pixel in the second display region includes only the second color sub-pixel or only the third color sub-pixel, the color-combining device is a color-combining prism or an optical waveguide color-combining device. In a case where a pixel in the second display region includes both the second color sub-pixel and the third color sub-pixel, the color-combining device is a color-combining prism.

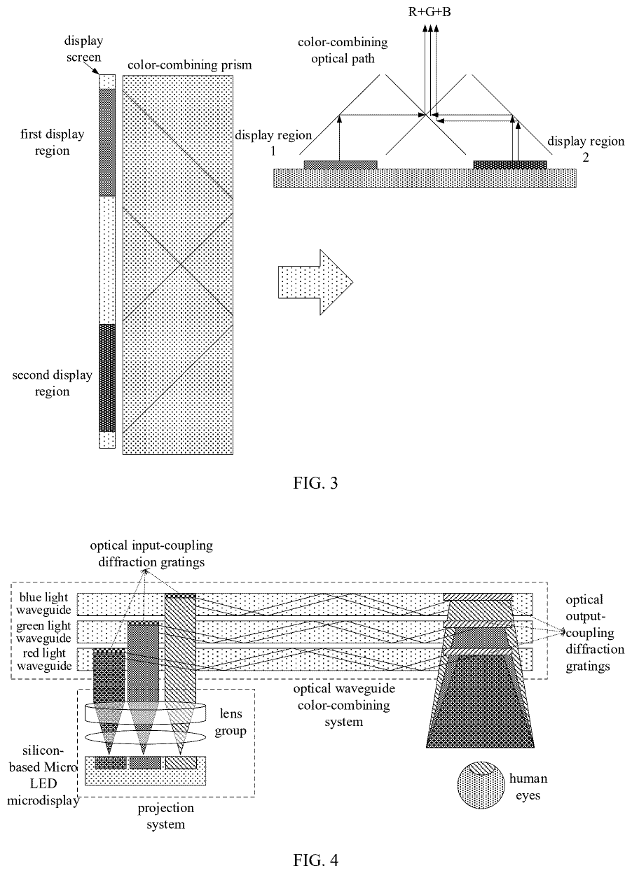

Optionally, if the color-combining device is a color-combining prism, a schematic diagram of an optical engine system, and a color-combining optical path diagram of the color-combining prism are shown in FIG. 3, the display region 1 represents the first display region, and the display region 2 represents the second display region.

In some embodiments, the optical waveguide color-combining device includes first optical input-coupling diffraction gratings, a first optical waveguide channel, and first optical output-coupling diffraction gratings that correspond to the first display region, and second optical input-coupling diffraction gratings, a second optical waveguide channel, and second optical output-coupling diffraction gratings that correspond to the second display region. The first optical input-coupling diffraction gratings are configured to import the light rays emitted from the first display region into the first optical waveguide channel through diffraction. The first optical waveguide channel is configured to transmit the imported light rays to the first optical output-coupling diffraction gratings. The first optical output-coupling diffraction gratings are configured to export, through diffraction, the light rays transmitted by the first optical waveguide channel. The second optical input-coupling diffraction gratings are configured to import light rays emitted from the second display region into the second optical waveguide channel through diffraction. The second optical waveguide channel is configured to transmit the imported light rays to the second optical output-coupling diffraction gratings. The second optical output-coupling diffraction gratings are configured to export, through diffraction, the light rays transmitted by the second optical waveguide channel.

Optionally, FIG. 4 shows an optical waveguide color-combining device capable of performing the color combining on the red light, green light, and blue light. In the embodiment, an optical waveguide color-combining device capable of performing the color combining on two colors of light can be manufactured according to the requirements of the first display region and the second display region. For example, a pixel in the first display region includes a red sub-pixel, and a pixel in the second display region includes a blue sub-pixel. In this case, the optical waveguide color-combining device only needs to be capable of performing the color combining on red light and blue light, and the optical waveguide color-combining device only needs to include optical input-coupling diffraction gratings, optical waveguide channels, and optical output-coupling diffraction gratings corresponding to the red light and blue light.

Optionally, light rays exported from different optical output-coupling diffraction gratings may be combined, so that a picture in a to-be-displayed image is formed in human eyes.

In some embodiments, a grating plane of any one of the first optical input-coupling diffraction gratings, the second optical input-coupling diffraction gratings, the first optical output-coupling diffraction gratings, or the second optical output-coupling diffraction gratings is engraved with a plurality of grooves, an incident angle of the diffraction grating is related to a width and a blaze angle of the groove, and a diffraction angle of the diffraction grating is related to the width and the blaze angle of the groove. The incident angle is an angle between the incident light ray and the grating normal, the diffraction angle is an angle between the diffracted light ray and the grating normal, and the blaze angle is an angle between an inclined surface of the groove and the grating plane.

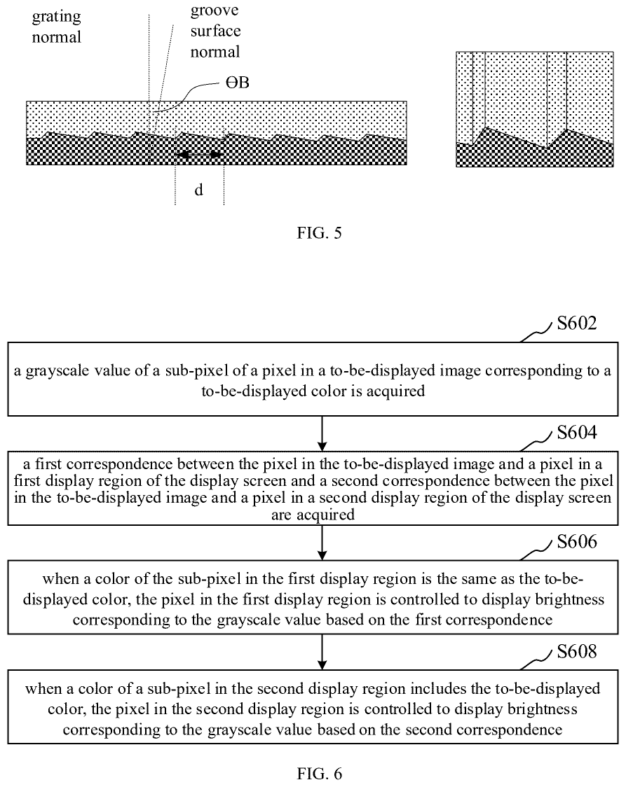

Optionally, diffraction gratings corresponding to the blue light are taken as an example. FIG. 5 is a schematic diagram of the diffraction gratings. In FIG. 5, d denotes the width of a groove, and OB denotes a blaze angle of a diffraction grating corresponding to the blue light. It may be learned from a grating equation in an incidence case that a formula (a blaze condition) for determining a maximum interference of all levels is shown as follows:

$$2 d sin θ B = m λ ,$$

where m denotes an interference level, and 2 denotes a blue light wavelength.

Optionally, the diffraction grating has a micro-nano structure, and grooves on a surface of the grating are formed by etching a surface of a glass by using semiconductor etching, nano-imprinting, and other technologies, to form different contrasts.

Optionally, the width and the blaze angle of the groove may be determined based on a wavelength/of corresponding color light.

In some embodiments, in a case where the color-combining device is an optical waveguide color-combining device, the system may further include a lens group consisting of a plurality of lenses. The lens group is configured to process different light rays emitted from the display screen, so that light rays incident on the same optical input-coupling diffraction grating are parallel to each other.

Optionally, as shown in FIG. 4, a set of lenses refers to a lens group.

In an embodiment, as shown in FIG. 6, a display method for a display screen is provided, and the method is applied to the optical engine system in FIG. 1 as an example for illustration. The method may include the following steps.

S602: a grayscale value of a sub-pixel of a pixel in a to-be-displayed image corresponding to a to-be-displayed color is acquired.

Optionally, if a pixel in the to-be-displayed image includes sub-pixels of two colors, the to-be-displayed color includes the two colors. If a pixel in the to-be-displayed image includes sub-pixels of three colors, the to-be-displayed color includes red, green, and blue.

S604: a first correspondence between the pixel in the to-be-displayed image and a pixel in a first display region of the display screen and a second correspondence between the pixel in the to-be-displayed image and a pixel in a second display region of the display screen are acquired.

Optionally, there may exist a one-to-one correspondence, a one-to-many correspondence, or a many-to-one correspondence between the pixel in the to-be-displayed image and the pixel in the first display region of the display screen, which is not specifically limited in the embodiments of the present disclosure. There may exist a one-to-one correspondence, a one-to-many correspondence, or a many-to-one correspondence between the pixel in the to-be-displayed image and the pixel in the second display region of the display screen, which is not specifically limited in the embodiments of the present disclosure.

S606: when the color of the sub-pixel in the first display region is the same as the to-be-displayed color, the pixel in the first display region is controlled to display brightness corresponding to the grayscale value based on the first correspondence.

Optionally, a gamma curve of the display screen may be first acquired, then a brightness value corresponding to the grayscale value is determined from the gamma curve, and the pixel in the first display region is controlled to perform the display based on the brightness value.

Optionally, the first correspondence is configured to determine a pixel in the first display region corresponding to a pixel in the to-be-displayed image.

S608: when a color of a sub-pixel in the second display region includes the to-be-displayed color, the pixel in the second display region is controlled to display brightness corresponding to the grayscale value based on the second correspondence.

Optionally, a pixel in the second display region corresponding to the pixel in the to-be-displayed image is determined based on the second correspondence, and a sub-pixel in the determined pixel corresponding to the to-be-displayed color is controlled to perform the display based on a grayscale value corresponding to the to-be-displayed color.

In the above display method for the display screen, a grayscale value of a sub-pixel of a pixel in a to-be-displayed image corresponding to a to-be-displayed color is acquired, a first correspondence between the pixel in the to-be-displayed image and a pixel in a first display region of the display screen and a second correspondence between the pixel in the to-be-displayed image and a pixel in a second display region of the display screen are acquired, the pixel in the first display region is controlled to display brightness corresponding to the grayscale value based on the first correspondence when a color of the sub-pixel in the first display region is the same as the to-be-displayed color, and the pixel in the second display region is controlled to display brightness corresponding to the grayscale value based on the second correspondence when a color of a sub-pixel in the second display region includes the to-be-displayed color. According to the method provided in the embodiment, the picture in the to-be-displayed image can be accurately displayed in human eyes.

It should be appreciated that, although steps in the flow charts related to the above embodiments are sequentially displayed in an order indicated by arrows, these steps are not necessarily sequentially performed according to the order indicated by the arrows. Unless expressly stated in the specification, these steps are not performed according to a strict sequence restriction, and these steps may be performed in other orders. In addition, at least a part of the steps in the flow charts involved in the above embodiments may include multiple steps or multiple phases. These steps or phases are not necessarily performed at the same moment, but may be performed at different moments. These steps or phases are not necessarily performed sequentially, but may be performed in turns or alternately with other steps or at least a part of steps or phases in other steps.

Based on the same invention concept, in an embodiment of the present disclosure, a display apparatus for a display screen for implementing the above-mentioned display method for the display screen is provided. An implementation solution provided by the apparatus to solve the technical problem is similar to the implementation solution described in the above method. Therefore, for specific limitations in one or more embodiments of the display apparatus provided below, reference can be made to the above limitations on the display method for the display screen, and details are not repeated herein again.

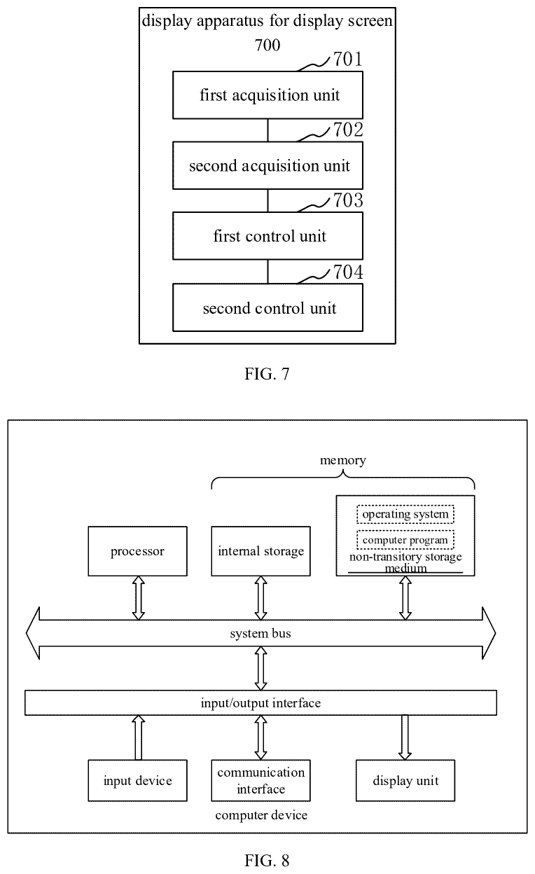

In an exemplary embodiment, as shown in FIG. 7, a display apparatus 700 for a display screen is provided, which includes a first acquisition unit 701, a second acquisition unit 702, a first control unit 703, and a second control unit 704.

The first acquisition unit 701 is configured to acquire a grayscale value of a sub-pixel of a pixel in a to-be-displayed image corresponding to a to-be-displayed color.

The second acquisition unit 702 is configured to acquire a first correspondence between the pixel in the to-be-displayed image and a pixel in a first display region of the display screen and a second correspondence between the pixel in the to-be-displayed image and a pixel in a second display region of the display screen.

The first control unit 703 is configured to control the pixel in the first display region to display brightness corresponding to the grayscale value based on the first correspondence when a color of a sub-pixel in the first display region is the same as the to-be-displayed color.

The second control unit 704 is configured to control the pixel in the second display region to display brightness corresponding to the grayscale value based on the second correspondence when a color of a sub-pixel in the second display region includes the to-be-displayed color.

All or part of the units in the above display apparatus for the display screen may be implemented by using software, hardware, or a combination thereof. The units may be embedded in or independent of a processor in a computer device in a hardware form, or may be stored in a memory in the computer device in a software form, so that the processor can invoke and execute operations corresponding to the units.

In an exemplary embodiment, a computer device is provided. The computer device may be a terminal, and an internal structure diagram of the computer device may be as shown in FIG. 8. The computer device may include a processor, a memory, an input/output interface, a communication interface, a display unit, and an input device. The processor, the memory, and the input/output interface are connected to each other through a system bus. The communication interface, the display unit, and the input device are connected to the system bus through the input/output interface. The processor of the computer device is configured to provide computing and control capabilities. The memory of the computer device may include a non-transitory storage medium and an internal storage. The non-transitory storage medium stores an operating system and a computer program. The internal storage provides an environment for operations of the operating system and the computer program in the non-transitory storage medium. The input/output interface of the computer device is configured to exchange information between the processor and an external device. The communication interface of the computer device is configured to communicate with an external terminal in a wired or wireless mode. The wireless mode may be implemented through WIFI, a mobile cellular network, Near Field Communication (NFC), or other technologies. The computer program is executed by the processor to implement a display method for a display screen.

A person skilled in the art may understand that the structure shown in FIG. 8 is merely a block diagram of a partial structure related to the solution of the present disclosure, and does not constitute a limitation on a computer device to which the solution of the present disclosure is applied. A specific computer device may include more or fewer components than those shown in the figure, or combine some components, or have different component arrangements.

In an exemplary embodiment, a computer device is provided, which includes a processor and a memory storing a computer program. The processor, when executing the computer program, may implement the following steps of: acquiring a grayscale value of a sub-pixel of a pixel in a to-be-displayed image corresponding to a to-be-displayed color; acquiring a first correspondence between the pixel in the to-be-displayed image and a pixel in a first display region of the display screen and a second correspondence between the pixel in the to-be-displayed image and a pixel in a second display region of the display screen; controlling the pixel in the first display region to display brightness corresponding to the grayscale value based on the first correspondence when a color of a sub-pixel in the first display region is the same as the to-be-displayed color; and controlling the pixel in the second display region to display brightness corresponding to the grayscale value based on the second correspondence when a color of a sub-pixel in the second display region includes the to-be-displayed color.

In an embodiment, a non-transitory computer-readable storage medium is provided, on which a computer program is stored. The computer program, when executed by a processor, may cause the processor to implement the following steps of: acquiring a grayscale value of a sub-pixel of a pixel in a to-be-displayed image corresponding to a to-be-displayed color; acquiring a first correspondence between the pixel in the to-be-displayed image and a pixel in a first display region of the display screen and a second correspondence between the pixel in the to-be-displayed image and a pixel in a second display region of the display screen; controlling the pixel in the first display region to display brightness corresponding to the grayscale value based on the first correspondence when a color of a sub-pixel in the first display region is the same as the to-be-displayed color; and controlling the pixel in the second display region to display brightness corresponding to the grayscale value based on the second correspondence when a color of a sub-pixel in the second display region includes the to-be-displayed color.

In an embodiment, a computer program product is provided, which includes a computer program. The computer program, when executed by a processor, may cause the processor to implement the following steps of: acquiring a grayscale value of a sub-pixel of a pixel in a to-be-displayed image corresponding to a to-be-displayed color; acquiring a first correspondence between the pixel in the to-be-displayed image and a pixel in a first display region of the display screen and a second correspondence between the pixel in the to-be-displayed image and a pixel in a second display region of the display screen; controlling the pixel in the first display region to display brightness corresponding to the grayscale value based on the first correspondence when a color of a sub-pixel in the first display region is the same as the to-be-displayed color; and controlling the pixel in the second display region to display brightness corresponding to the grayscale value based on the second correspondence when a color of a sub-pixel in the second display region includes the to-be-displayed color.

It should be noted that user information (including but not limited to user device information, user personal information, and the like) and data (including but not limited to data used for analysis, stored data, and displayed data) involved in the present disclosure are authorized by a user or fully authorized by each party, and collection, use, and processing of related data need to comply with a related regulation.

A person of ordinary skill in the art may understand that all or a part of the processes in the above-mentioned embodiments of the method may be implemented by a computer program instructing related hardware. The computer program may be stored in a non-transitory computer-readable storage medium. When the computer program is executed, the processes in the above-mentioned method embodiments may be included. Any reference to a memory, a database, or other media used in the embodiments provided in the present disclosure may include at least one of a non-transitory memory or a transitory memory. The non-transitory memory may include a Read-Only Memory (ROM), a magnetic tape, a floppy disk, a flash memory, an optical memory, a high-density embedded non-transitory memory, a Resistive Random Access Memory (ReRAM), a Magnetoresistive Random Access Memory (MRAM), a Ferroelectric Random Access Memory (FRAM), a Phase Change Memory (PCM), a graphene memory, and the like. The transitory memory may include a Random Access Memory (RAM), an external cache, or the like. As an illustration and not a limitation, the RAM may be in multiple forms, such as a Static Random Access Memory (SRAM) or a Dynamic Random Access Memory (DRAM). The databases involved in the embodiments provided in the present disclosure may include at least one of a relational database or a non-relational database. The non-relational database may include a block chain based distributed database or the like, which is not limited thereto. The processor involved in the embodiments provided in the present disclosure may be a general purpose processor, a central processing unit, a graphics processor, a digital signal processor, a programmable logic device, a quantum computing-based data processing logic device, an Artificial Intelligence (AI) processor, or the like, which is not limited thereto.

The technical features in the above-mentioned embodiments may be combined in any manner. To make the description brief, all possible combinations of the technical features in the above-mentioned embodiments are not described. However, as long as there is no contradiction between the combinations of the technical features, it should be considered that the combinations of the technical features are within the scope described in the present disclosure.

The above-mentioned embodiments represent only several implementation modes of the present disclosure, and description thereof is relatively specific and detailed, but may not be construed as a limitation on the scope of the present disclosure. It should be noted that a person of ordinary skill in the art may make some modifications and improvements without departing from the concept of the present disclosure, which are within the protection scope of the present disclosure. Therefore, the protection scope of the present disclosure shall be subject to the appended claims.

1. An optical engine system, comprising:
a display screen and a color-combining device, wherein
the display screen comprises a first display region and a second display region, a pixel in the first display region comprises a first color sub-pixel, a pixel in the second display region comprises at least one of a second color sub-pixel or a third color sub-pixel, wherein the first color, the second color, and the third color are respectively one of three primary colors, pixels in the first display region are in a one-to-one correspondence with pixels in the second display region,
the display screen is configured to receive a grayscale value of a sub-pixel in a to-be-displayed image corresponding to a color, to display brightness corresponding to the grayscale value in the first display region or the second display region that comprises the sub-pixel of the color, color types of sub-pixels included in pixels in the to-be-displayed image are the same as color types of sub-pixels in the display screen, and
the color-combining device is configured to combine a light ray emitted from the first display region and a light ray emitted from the second display region.

2. The system according to claim 1, wherein when the pixel in the second display region comprises only the second color sub-pixel or only the third color sub-pixel, the color-combining device is a color-combining prism or an optical waveguide color-combining device; and when the pixel in the second display region comprises both the second color sub-pixel and the third color sub-pixel, the color-combining device is the color-combining prism.

3. The system according to claim 2, wherein the optical waveguide color-combining device comprises:
first optical input-coupling diffraction gratings, a first optical waveguide channel, and first optical output-coupling diffraction gratings that correspond to the first display region, and second optical input-coupling diffraction gratings, a second optical waveguide channel, and second optical output-coupling diffraction gratings that correspond to the second display region, wherein
the first optical input-coupling diffraction gratings are configured to import light rays emitted from the first display region into the first optical waveguide channel through diffraction,
the first optical waveguide channel is configured to transmit the imported light rays to the first optical output-coupling diffraction gratings,
the first optical output-coupling diffraction gratings are configured to export, through diffraction, the light rays transmitted by the first optical waveguide channel,
the second optical input-coupling diffraction gratings are configured to import light rays emitted from the second display region into the second optical waveguide channel through diffraction,
the second optical waveguide channel is configured to transmit the imported light rays to the second optical output-coupling diffraction gratings, and
the second optical output-coupling diffraction gratings are configured to export, through diffraction, the light rays transmitted by the second optical waveguide channel.

4. The system according to claim 3, wherein a grating plane of any one diffraction grating of the first optical input-coupling diffraction gratings, the second optical input-coupling diffraction gratings, the first optical output-coupling diffraction gratings, or the second optical output-coupling diffraction gratings is engraved with a plurality of grooves, an incident angle of the diffraction grating is related to a width and a blaze angle of a groove, and a diffraction angle of the diffraction grating is related to the width and the blaze angle of the groove, wherein the incident angle is an angle between an incident light ray and a grating normal, the diffraction angle is an angle between a diffracted light ray and the grating normal, and the blaze angle is an angle between an inclined surface of the groove and the grating plane.

5. The system according to claim 2, wherein when the color-combining device is the optical waveguide color-combining device, the system further comprises a lens group consisting of a plurality of lenses,
wherein the lens group is configured to process different light rays emitted from the display screen, to allow light rays incident on the same optical input-coupling diffraction grating to be parallel to each other.

6. A display method for a display screen, applied to the optical engine system of claim 1, the method comprising:
acquiring a grayscale value of a sub-pixel of a pixel in a to-be-displayed image corresponding to a to-be-displayed color;
acquiring a first correspondence between the pixel in the to-be-displayed image and a pixel in a first display region of the display screen, and a second correspondence between the pixel in the to-be-displayed image and a pixel in a second display region of the display screen;
controlling the pixel in the first display region to display brightness corresponding to the grayscale value based on the first correspondence when a color of a sub-pixel in the first display region is the same as the to-be-displayed color; and
controlling the pixel in the second display region to display brightness corresponding to the grayscale value based on the second correspondence when a color of a sub-pixel in the second display region includes the to-be-displayed color.

7. A display apparatus for a display screen, comprising:
a first acquisition unit, configured to acquire a grayscale value of a sub-pixel of a pixel in a to-be-displayed image corresponding to a to-be-displayed color;
a second acquisition unit, configured to acquire a first correspondence between the pixel in the to-be-displayed image and a pixel in a first display region of the display screen and a second correspondence between the pixel in the to-be-displayed image and a pixel in a second display region of the display screen;
a first control unit, configured to control the pixel in the first display region to display brightness corresponding to the grayscale value based on the first correspondence when a color of a sub-pixel in the first display region is the same as the to-be-displayed color; and
a second control unit, configured to control the pixel in the second display region to display brightness corresponding to the grayscale value based on the second correspondence when a color of a sub-pixel in the second display region includes the to-be-displayed color.

8. A computer device, comprising a processor and a memory storing a computer program, wherein the processor, when executing the computer program, implements the method of claim 6.

9. A non-transitory computer-readable storage medium, on which a computer program is stored, wherein the computer program, when executed by a processor, causes the processor to implement the method of claim 6.

10. A computer program product, comprising a computer program, wherein the computer program, when executed by a processor, causes the processor to implement the method of claim 6.
